(19) United States
(12) Patent Application Publication
(10) Pub. No.: US 2024/0039074 A1
(43) Pub. Date: Feb. 1, 2024

(54) Self-Heating Structure and Battery Pack Including the Same

(71) Applicant: EVE POWER CO., LTD., Jingmen (CN)

(72) Inventors: Xingwen Jian, Jingmen (CN); Tingting Pei, Jingmen (CN); Liquan Chen, Jingmen (CN); Yarong Li, Jingmen (CN); Tianyu Wu, Jingmen (CN); Gang Yang, Jingmen (CN); Xiang Chen, Jingmen (CN); Man Wen, Jingmen (CN)

(21) Appl. No.: 18/379,705

(22) Filed: Oct. 13, 2023

(30) Foreign Application Priority Data
Feb. 16, 2023 (CN) 202320253125.X

(51) Int. Cl. H01M 10/615; H01M 10/6571; H01M 10/654; H01M 10/63; H01M 10/48; H05B 3/22

(52) U.S. Cl. CPC H01M 10/615; H01M 10/6571; H01M 10/654; H01M 10/63; H01M 10/486; H05B 3/22

(57) ABSTRACT

Disclosed in the present application is a self-heating structure and a battery pack including the same. The self-heating structure includes a heating member, including a heating body and a connection lead molded on the heating body, the connection lead being used for electrically connecting a positive electrode tab of a core pack or a negative electrode tab of the core pack, so that a self-heating circuit is formed by the heating member and the core pack; and a control unit, controlling an on/off switching of the self-heating circuit according to temperature of the core pack, the control unit being provided on the connection lead to integrate the control unit and the connection lead.

### CROSS REFERENCE TO RELATED APPLICATIONS

The present application claims priority of Chinese Patent Application No. 202320253125.X filed on Feb. 16, 2023 before CNIPA. All the above are hereby incorporated by reference in their entirety.

### FIELD

The present application relates to the technical field of self-heating batteries, in particular to a self-heating structure and a battery pack including the same.

### BACKGROUND

As society develops and people pay more and more attention to environmental issues, new energy vehicle technology is recognized by more and more consumers, and it is expected that new energy vehicles may replace traditional vehicles gradually in the future. As the demand for new energy vehicles increases year by year, the limitations of climate for electric vehicles are becoming more and more obvious. It is well known that the performance of battery packs in low-temperature environments is limited, and the battery is even impossible to be charged. In order to address this problem and ensure the normal operation of the battery pack in a low-temperature environment, the current method adopted is: heating the battery by adopting the electrical energy of the battery pack itself to achieve self-heating of the battery.

However, the wiring of the self-heating circuit in the related technology is relatively complex, which requires a relatively large quantity of connecting wiring harnesses and electronic elements, and also requires a relatively high occupation of the internal space of the battery pack, which, on the one hand, reduces the energy density of the battery pack, and, on the other hand, increases the structural complexity and the production cost of the battery pack.

### SUMMARY

In order to overcome at least one defect mentioned above in the prior art, provided in the present application is a self-heating structure and a battery pack including the same, which aims to address the problem that existing self-heating circuits reduce the energy density of battery packs as well as increase the structural complexity and production cost of battery packs.

The technical solutions adopted by the present application to solve the problems are as follows.

A self-heating structure includes a heating member, including a heating body and a connection lead molded on the heating body, the connection lead being used for electrically connecting a positive electrode tab of a core pack or a negative electrode tab of the core pack, so that a self-heating circuit is formed by the heating member and the core pack; and a control unit, provided on the connection lead, the control unit controlling an on/off switching of the self-heating circuit according to a temperature of the core pack.

In the self-heating structure provided in the present application, the connection lead is molded on the heating body, which increases the structural strength and the working stability of the heating member. Importantly, a self-heating circuit is formed by the heating member and the core pack through the connection lead. Also, the control unit and the connection lead are integrated to simplify the wiring, which also reduces the quantity and type of other connection structures and electrical elements. The structure is simple and the function is easy to realize, which improves the space utilization of the battery pack to increase the energy density of the battery pack, and also reduces the structural complexity and production cost of the battery pack.

Specifically, when the core pack is under a relatively lower temperature, the core pack is unable to be charged or the charging efficiency is extremely low. Then the control unit turns on the self-heating circuit, and the heating member is energized to produce a rapid thermal effect so as to achieve the self-heating inside the core pack. When an interior of the core pack reaches a temperature for normal charging, the control unit turns off the self-heating circuit, so that the heating member stops producing the thermal effect when power is off, and the self-heating inside the core pack ends subsequently, which avoids overheating of the core pack so as to achieve the purpose of protecting the core pack.

According to some implementations of the present application, the control unit includes a first inductive member, the first inductive member being used for detecting a first temperature signal inside the core pack, the control unit controlling an on/off switching of the self-heating circuit according to the first temperature signal.

According to some implementations of the present application, a surface of the heating member is provided with a passivation layer.

According to some implementations of the present application, the heating member is a metal foil, and the passivation layer is formed on a surface of the metal foil.

As another aspect, provided in the present application is a battery pack, including a core pack and the self-heating structure mentioned above.

According to some implementations of the present application, the connection lead is electrically connected to the positive electrode tab of the core pack.

According to some implementations of the present application, the connection lead is integrally connected to the positive electrode tab of the core pack.

According to some implementations of the present application, the heating member extends along a large surface of the core pack and is provided in contact with the large surface of the core pack.

According to some implementations of the present application, a projection of the heating member on the core pack does not extend beyond the large surface of the core pack.

According to some implementations of the present application, the battery pack also includes a housing; one or more of the core packs constitutes a battery module, the battery module being provided in the housing; and the heating member is clamped between the housing and the battery module.

According to some implementations of the present application, the battery pack also includes a second inductive member, the second inductive member being provided on a surface of the core pack; and the second inductive member is used for detecting a second temperature signal of the surface of the core pack, so that an on/off switching of the self-heating circuit is controlled according to the second temperature signal.

### BRIEF DESCRIPTION OF THE DRAWINGS

FIG. 1 is a structural diagram in a perspective view of the battery pack in an embodiment of the present application;

FIG. 2 is a structural diagram of the self-heating structure and the battery module in an embodiment of the present application;

FIG. 3 is a structural diagram in an exploded view of the self-heating structure and the core pack in an embodiment of the present application.

The meanings of the attached markings are as follows:

1 battery pack; 10 heating member; 101 heating body; 102 connection lead; 11 battery module; 111 core pack; 1111 positive electrode sheet; 1112 positive electrode tab; 1113 negative electrode sheet; 1114 negative electrode tab; 12 housing; 13 separator.

### DETAILED DESCRIPTION OF THE PREFERRED EMBODIMENTS

In the description of the present application, it is to be noted that the terms “up”, “down”, “front”, “back”, “left”, “right”, “vertical”, “horizontal”, “top”, “bottom”, “inside”, “outside” and other orientation or position relationships are based on the orientation or position relationships shown in the attached drawings. It is only intended to facilitate description and simplify operation, but not to indicate or imply that the referred device or element has a specific orientation, or is constructed and operated in a specific orientation. Therefore, they should not be construed as a limitation of the present application.

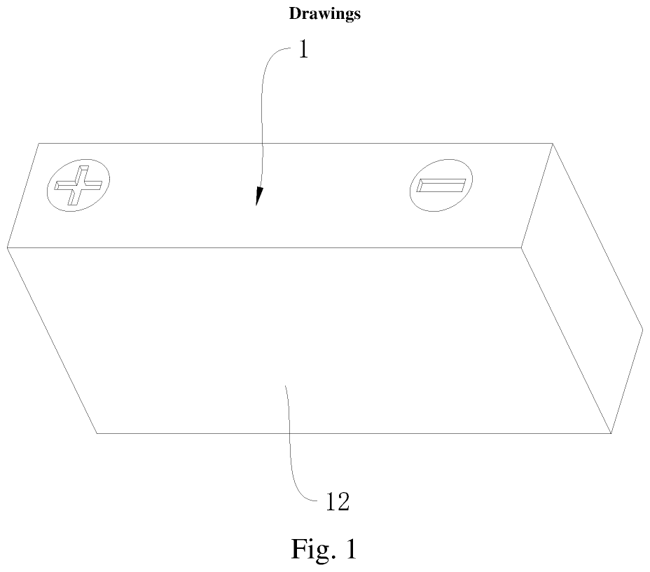

Referring to FIG. 1 to FIG. 3, disclosed in the present application is a self-heating structure and a battery pack 1 including the self-heating structure. Specifically, the battery pack 1 also includes a core pack 111 and a housing 12. The self-heating structure includes a heating member 10, including a heating body 101 and a connection lead 102 molded on the heating body 101, the connection lead 102 being used for electrically connecting a positive electrode tab 1112 of a core pack 111 or a negative electrode tab 1114 of the core pack 111, so that a self-heating circuit is formed by the heating member 10 and the core pack 111; and a control unit, the control unit being provided on the connection lead 102, the control unit controlling an on/off switching of the self-heating circuit according to a temperature of the core pack 111.

In such a setup, the connection lead 102 is molded on the heating body 101, which increases the structural strength and the working stability of the heating member 10. More importantly, a self-heating circuit is formed by the heating member 10 and the core pack 111 through the connection lead 102. Also, the control unit and the connection lead 102 are integrated to simplify the wiring, which also reduces the quantity and type of other connection structures and electrical elements. The structure is simple and the function is easy to realize, which improves the space utilization of the battery pack 1 to increase the energy density of the battery pack 1, and also reduces the structural complexity and production cost of the battery pack 1.

It is to be noted that the connection lead 102 is molded on the heating body 101, which may be, but is not limited to, such as integral injection molding, integral cut molding and integral press molding, which is not limited hereby.

Specifically, in the present embodiment, a width of the connection lead 102 is 3 m. Admittedly, in the other embodiments, the width of the connection lead 102 may also be, but is not limited to, such as 4 m, 5 m, 6 m and 7 m, which is not limited hereby.

Specifically, in the present embodiment, the control unit includes a first inductive member, the first inductive member being used for detecting a first temperature signal inside the core pack 111, the control unit controlling an on/off switching of the self-heating circuit according to the first temperature signal. Admittedly, in the other embodiments, the control unit may also be, but is not limited to, a temperature relay, which is not limited hereby.

Further, in the present embodiment, the battery pack 1 also includes a second inductive member, the second inductive member being provided on a surface of the core pack 111; and the second inductive member is used for detecting a second temperature signal of the surface of the core pack 111, so that an on/off switching of the self-heating circuit is controlled according to the second temperature signal. In such a setup, the temperature of an interior of the core pack 111 and a surface of the core pack 111 is detected by the first inductive member and the second inductive member respectively, which achieves a double detection of the temperature of the core pack 111, which ensures the detection accuracy of the temperature of the core pack 111, so as to precisely control an on/off switching of the self-heating circuit, thereby improving the charging efficiency of the core pack 111 under a low-temperature environment.

It is to be noted that, in some embodiments, the first inductive member and the second inductive member are equivalent to inductive switches. When the detected temperature signal is lower than a preset value, the first sensing member and the second sensing member are turned on to energize the self-heating circuit; when the detected temperature signal is higher than the preset value, the second sensing member and the second sensing member are turned off to disconnect the self-heating circuit.

It is to be noted that, in some embodiments, the first inductive member and the second inductive member are equivalent to sensors. The control module receives a first temperature signal and a second temperature signal and controls an on/off switching of the self-heating circuit according to the first temperature signal and the second temperature signal. Specifically, the control module may be, but is not limited to, a battery management system (BMS) of the battery pack 1.

Specifically, in the present embodiment, when the core pack 111 is under a relatively lower temperature, the core pack 111 is unable to be charged or the charging efficiency is extremely low. Then the first inductive member and the second inductive member turn on the self-heating circuit, and the heating member 10 is energized to produce a rapid thermal effect in order to achieve the self-heating inside the core pack 111. When an interior of the core pack 111 reaches a temperature for normal charging, the first inductive member and the second inductive member turn off the self-heating circuit, so that the heating member 10 stops producing the thermal effect when power is off, and the self-heating inside the core pack 111 ends subsequently, which avoids overheating of the core pack 111 to achieve the purpose of protecting the core pack 111.

It is to be noted that, in some other embodiment, it is also possible to provide only the first inductive member without the second inductive member to save production costs.

Further, in the present embodiment, a surface of the heating member 10 is provided with a passivation layer to prevent the heating member 10 from corroding by electrolyte, so as to prevent the heating member 10 from working abnormally. Exemplarily, it may avoid direct conductivity between the heating member 10 and the electrolyte, which may fail the self-heating circuit or cause the heating member 10 to produce heat excessively.

Preferably, in the present embodiment, the heating member 10 is a metal foil, and the passivation layer is formed on a surface of the metal foil. In such a setup, the passivation layer and the metal foil become an integral structure, which may prevent the passivation layer from shedding and failing due to long-term use, and greatly improve the security performance. Exemplarily, the metal foil may be processed by concentrated sulfuric acid (98% concentration), so that the passivation layer may be formed on the surface of the metal foil.

It is to be noted that, in some other embodiments, the heating member 10 may also be, but is not limited to, graphite. The passivation layer may be, but is not limited to, such as phenylethylammonium iodide and phenylmethylammonium iodide, which is not limited hereby.

Referring to FIG. 3, it is to be understood that, the core pack 111 is formed by stacking or winding a plurality of positive electrode sheets 1111 and a plurality of negative electrode sheets 1113, and a separator 13 is provided between two adjacent electrode sheets. A positive electrode tab 1112 is provided on the positive electrode sheet 1111, and a negative electrode tab 1114 is provided on the negative electrode sheet 1113, in which the quantity of the negative electrode sheets 1113 is generally greater than the quantity of positive electrode sheets 1111 to prevent short-circuiting within the core pack 111. Specifically, in the present embodiment, the positive electrode sheet 1111, the heating member 10, and the negative electrode sheet 1113 are in decreasing order of chemical activity. More specifically, the positive electrode sheet 1111 may be, but is not limited to, an aluminum foil; the heating member 10 may be, but is not limited to, a nickel foil; and the negative electrode sheet 1113 may be, but is not limited to, a copper foil.

Preferably, in the present embodiment, the connection lead 102 is electrically connected to the positive electrode tab 1112 of the core pack 111, so that a self-heating circuit is formed by the positive electrode sheet 1111 and the heating member 10. In such a setup, the positive electrode sheet 1111 is equivalent to a positive electrode, and the heating member 10 is equivalent to a negative electrode. In such a setup, it avoids forming a loop between the heating member 10 and the negative electrode sheet 1113 and prevents the negative electrode sheet 1113 from being depleted resulting in an accident.

Preferably, in the present embodiment, in order to improve the connection strength and the working stability, the connection lead 102 is integrally connected to the positive electrode tab 1112 of the core pack 111. Specifically, the connection may be, but is not limited to, such as welding connection and hot riveting connection, which is not limited hereby.

Admittedly, in some other embodiments, the connection lead 102 may be integrally connected to the negative electrode tab 1114 of the core pack 111, so that a self-heating circuit is formed by the negative electrode sheet 1113 and the heating member 10. In such a setup, the heating member 10 is equivalent to a positive electrode, and the negative electrode sheet 1113 is equivalent to a negative electrode.

Further, in the present embodiment, in order to increase the surface contact area with the core pack 111, the heating member 10 is in the shape of a sheet, and the heating member 10 extends along and is provided in contact with a large surface of the core pack 111 to improve the heat transfer performance, which increases the rate of temperature increase of the core pack 111.

Preferably, in the present embodiment, in order to avoid the problem that the dimension of the heating member 10 is oversize and occupies too much space of the battery pack 1, the projection of the heating member 10 on the core pack 111 does not extend beyond a large surface of the core pack 111, so as to ensure that the battery pack 1 is able to provide a high space utilization rate and energy density.

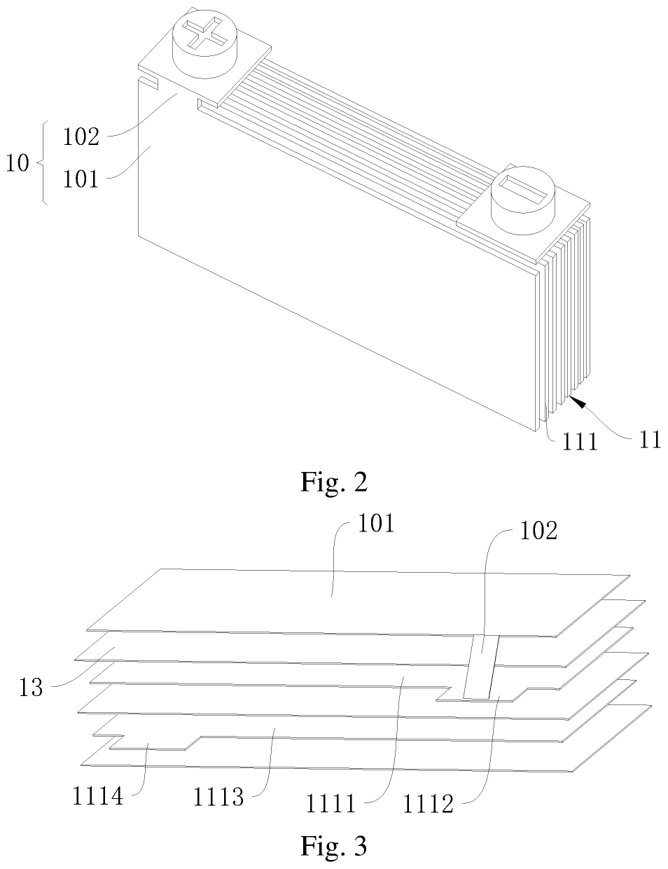

As shown in FIG. 1 and FIG. 2, preferably, in the present embodiment, a plurality of core packs 111 constitutes a battery module 11, the battery module 11 being provided in the housing 12; and the heating member 10 is clamped between the housing 12 and the battery module 11.

Compared to providing the heating member 10 between two core packs 111, such a setup may improve the safety performance of the battery pack 1 and eliminate potential hazards.

Specifically, in the present embodiment, a thickness of a battery reinforcing sheet is close to that of an electrode sheet, which facilitates to control an overall dimension and assembly of the battery pack 1. More specifically, a thickness of the reinforcing sheet may be, but is not limited to, such as 45 m, 50 m and 55 m, which is not limited hereby.

In summary, the self-heating structure and the battery pack 1 including the same disclosed in the present application may provide at least the following beneficial technical effects:
1) The connection lead is molded on the heating body 101, which improves the structural strength and the working stability of the heating member 10.
2) A self-heating circuit is formed by the heating member 10 and the core pack 111 through the connection lead 102. Also, the control unit and the connection lead 102 are integrated to simplify the wiring, which also reduces the quantity and type of other connection structures and electrical elements. The structure is simple and the function is easy to realize, which improves the space utilization of the battery pack 1 to increase the energy density of the battery pack 1, and also reduces the structural complexity and production cost of the battery pack 1.
3) A surface of the heating member 10 is provided with a passivation layer to prevent the heating member 10 from corroding by electrolyte, so as to prevent the heating member 10 from working abnormally, which may avoid direct conductivity between the heating member 10 and the electrolyte that may fail the self-heating circuit or cause the heating member 10 to produce heat excessively.
4) The passivation layer is formed on a surface of the metal foil, so that the passivation layer and the metal foil become an integral structure, which may prevent the passivation layer from shedding and failing due to long-term use, and greatly improve the security performance.
5) The temperature of an interior of the core pack 111 and a surface of the core pack 111 is detected by the first inductive member and the second inductive member respectively, which achieves a double detection of the temperature of the core pack 111, which ensures the detection accuracy of the temperature of the core pack 111, so as to precisely control an on/off switching of the self-heating circuit, thereby improving the charging efficiency of the core pack 111 under a low temperature environment.

1. A self-heating structure, comprising:
a heating member, comprising a heating body and a connection lead molded on the heating body, the connection lead being used for electrically connecting a positive electrode tab of a core pack or a negative electrode tab of the core pack, so that a self-heating circuit is formed by the heating member and the core pack; and
a control unit, provided on the connection lead, the control unit controlling an on/off switching of the self-heating circuit according to temperature of the core pack.

2. The self-heating structure according to claim 1, wherein the control unit comprises a first inductive member, the first inductive member being used for detecting a first temperature signal inside the core pack, the control unit controlling an on/off switching of the self-heating circuit according to the first temperature signal.

3. The self-heating structure according to claim 1, wherein a surface of the heating member is provided with a passivation layer.

4. The self-heating structure according to claim 3, wherein the heating member is a metal foil, and the passivation layer is formed on a surface of the metal foil.

5. A battery pack, comprising a core pack and a self-heating structure, the self-heating structure comprising:
a heating member, comprising a heating body and a connection lead molded on the heating body, the connection lead being used for electrically connecting a positive electrode tab of a core pack or a negative electrode tab of the core pack, so that a self-heating circuit is formed by the heating member and the core pack; and
a control unit, provided on the connection lead, the control unit controlling an on/off switching of the self-heating circuit according to temperature of the core pack.

6. The battery pack according to claim 5, wherein the control unit comprises a first inductive member, the first inductive member being used for detecting a first temperature signal inside the core pack, the control unit controlling an on/off switching of the self-heating circuit according to the first temperature signal.

7. The battery pack according to claim 5, wherein a surface of the heating member is provided with a passivation layer.

8. The battery pack according to claim 7, wherein the heating member is a metal foil, and the passivation layer is formed on a surface of the metal foil.

9. The battery pack according to claim 5, wherein the connection lead is electrically connected to the positive electrode tab of the core pack.

10. The battery pack according to claim 9, wherein the connection lead is integrally connected to the positive electrode tab of the core pack.

11. The battery pack according to claim 5, wherein the heating member extends along a large surface of the core pack and is provided in contact with the large surface of the core pack.

12. The battery pack according to claim 11, wherein a projection of the heating member on the core pack does not extend beyond the large surface of the core pack.

13. The battery pack according to claim 5, wherein the battery pack also comprises a housing; one or more of the core packs constitutes a battery module, the battery module being provided in the housing; and the heating member is clamped between the housing and the battery module.

14. The battery pack according to claim 9, wherein the battery pack also comprises a housing; one or more of the core packs constitutes a battery module, the battery module being provided in the housing; and the heating member is clamped between the housing and the battery module.

15. The battery pack according to claim 10, wherein the battery pack also comprises a housing; one or more of the core packs constitutes a battery module, the battery module being provided in the housing; and the heating member is clamped between the housing and the battery module.

16. The battery pack according to claim 11, wherein the battery pack also comprises a housing; one or more of the core packs constitutes a battery module, the battery module being provided in the housing; and the heating member is clamped between the housing and the battery module.

17. The battery pack according to claim 5, wherein the battery pack also comprises a second inductive member, the second inductive member being provided on a surface of the core pack; and the second inductive member is used for detecting a second temperature signal of the surface of the core pack, so that an on/off switching of the self-heating circuit is controlled according to the second temperature signal.

18. The battery pack according to claim 9, wherein the battery pack also comprises a second inductive member, the second inductive member being provided on a surface of the core pack; and the second inductive member is used for detecting a second temperature signal of the surface of the core pack, so that an on/off switching of the self-heating circuit is controlled according to the second temperature signal.

19. The battery pack according to claim 10, wherein the battery pack also comprises a second inductive member, the second inductive member being provided on a surface of the core pack; and the second inductive member is used for detecting a second temperature signal of the surface of the core pack, so that an on/off switching of the self-heating circuit is controlled according to the second temperature signal.

20. The battery pack according to claim 11, wherein the battery pack also comprises a second inductive member, the second inductive member being provided on a surface of the core pack; and the second inductive member is used for detecting a second temperature signal of the surface of the core pack, so that an on/off switching of the self-heating circuit is controlled according to the second temperature signal.
